(19) United States
(12) Patent Application Publication
(10) Pub. No.: US 2022/0292546 A1
(43) Pub. Date: Sep. 15, 2022

(54) PERFORMANCE MARKETING APPLICATION

(71) Applicant: MGMS LLC, Las Vegas, NV (US)

(72) Inventor: Marius Gheorghita, Las Vegas, NV (US)

(21) Appl. No.: 17/192,829

(22) Filed: Mar. 4, 2021

(51) Int. Cl. G06Q 30/02

(52) U.S. Cl. CPC G06Q 30/0273; G06Q 30/0211; G06Q 30/0224; G06Q 30/0204

(57) ABSTRACT

Methods, systems, and devices for a performance marketing application are described. An example method may include determining characteristics of a user of a performance marketing application and identifying offers that are relevant to the user based at least in part on the characteristics, wherein the offers are associated with advertisers associated with the performance marketing application. The method may also include providing the offers to a computing device associated with the user, determining an acceptance a first offer, and providing an advertisement associated with the first offer. Another example method may include determining characteristics of a user and receiving offers that are relevant to the user based at least in part on the characteristics. The method may also include outputting the offers at an output device of a computing device, accepting one of the offers, and receiving an advertisement associated with the accepted offers at the computing device.

### SUMMARY

The described techniques relate to improved methods, systems, devices, and apparatuses that support performance marketing applications. Generally, the described techniques provide for an ad sharing platform that connects promoters with advertisers who want to provide advertisements to consumers. The ad sharing platform uses information about a promoter to match an offer from an advertiser with the promoter. The promoter may receive an advertisement associated with the offer and link the advertisement in a channel. Consumers who use the link in the advertisement in the channel to complete a commercial transaction may trigger an award made to the promoter. The ad sharing platform may be a mobile or other computer application.

A method is described. The method may include determining one or more characteristics of a user of a performance marketing application. The method may also include identifying one or more offers from a set of multiple offers that are relevant to the user based on the one or more characteristics, where each of the set of multiple offers is associated with at least one of a set of multiple advertisers associated with the performance marketing application. The method may also include providing the one or more offers to a computing device associated with the user, determining an acceptance of a first offer of the one or more offers, and providing an advertisement associated with the first offer to the computing device.

An apparatus is described. The apparatus may include a processor, memory in electronic communication with the processor, and instructions stored in the memory. The instructions may be executable by the processor to cause the apparatus to determine one or more characteristics of a user of a performance marketing application and identify one or more offers from a set of multiple offers that are relevant to the user based on the one or more characteristics, where each of the set of multiple offers is associated with at least one of a set of multiple advertisers associated with the performance marketing application. The instructions may be further executable by the processor to cause the apparatus to provide the one or more offers to a computing device associated with the user, determine an acceptance of a first offer of the one or more offers, and provide an advertisement associated with the first offer to the computing device.

Another apparatus is described. The apparatus may include means for determining one or more characteristics of a user of a performance marketing application and means for identifying one or more offers from a set of multiple offers that are relevant to the user based on the one or more characteristics, where each of the set of multiple offers is associated with at least one of a set of multiple advertisers associated with the performance marketing application. The apparatus may also include means for providing the one or more offers to a computing device associated with the user, means for determining an acceptance of a first offer of the one or more offers, and means for providing an advertisement associated with the first offer to the computing device.

A non-transitory computer-readable medium storing code is described. The code may include instructions executable by a processor to determine one or more characteristics of a user of a performance marketing application and identify one or more offers from a set of multiple offers that are relevant to the user based on the one or more characteristics, where each of the set of multiple offers is associated with at least one of a set of multiple advertisers associated with the performance marketing application. The code may also include instructions executable by a processor to provide the one or more offers to a computing device associated with the user, determine an acceptance of a first offer of the one or more offers, and provide an advertisement associated with the first offer to the computing device.

In some examples of the method, apparatuses, and non-transitory computer-readable medium described herein, the advertisement includes a tracker and the method, apparatuses, and non-transitory computer-readable medium may include further operations, features, means, or instructions for determining that the tracker may have been used to complete a transaction associated with the first offer, causing an award to be made to the user based on the determination that the tracker may have been used to complete the transaction, and outputting an indication of the award to the user.

Some examples of the method, apparatuses, and non-transitory computer-readable medium described herein may further include operations, features, means, or instructions for determining that the transaction associated with the first offer may be a valid transaction.

Some examples of the method, apparatuses, and non-transitory computer-readable medium described herein may further include operations, features, means, or instructions for storing the set of multiple offers in an offer database associated with the performance marketing application, where each offer in the offer database may be associated with an advertiser of the set of multiple advertisers.

In some examples of the method, apparatuses, and non-transitory computer-readable medium described herein, at least some offers of the set of multiple offers in the offer database may be associated with an expiration of the offer.

Some examples of the method, apparatuses, and non-transitory computer-readable medium described herein may further include operations, features, means, or instructions for identifying one or more offers from a set of multiple offers that may be relevant to the user may be further based on a previous offer associated with the user.

Some examples of the method, apparatuses, and non-transitory computer-readable medium described herein may further include operations, features, means, or instructions for linking the advertisement to at least one channel of the user.

Some examples of the method, apparatuses, and non-transitory computer-readable medium described herein may further include operations, features, means, or instructions for requesting information related to the one or more characteristics of the user.

Some examples of the method, apparatuses, and non-transitory computer-readable medium described herein may further include operations, features, means, or instructions for storing information related to the one or more characteristics of the user in a promoter database associated with the performance marketing application.

In some examples of the method, apparatuses, and non-transitory computer-readable medium described herein, providing the advertisement associated with the first offer to the computing device may include operations, features, means, or instructions for outputting an indication of the advertisement at an output device of the computing device.

Some examples of the method, apparatuses, and non-transitory computer-readable medium described herein may further include operations, features, means, or instructions for publishing information related to the one or more offers on a webpage associated with the user.

In some examples of the method, apparatuses, and non-transitory computer-readable medium described herein, identifying one or more offers from the set of multiple offers that may be relevant to the user may include operations, features, means, or instructions for identifying the one or more offers from the set of multiple offers based on one or more characteristics associated with the one or more offers.

Some examples of the method, apparatuses, and non-transitory computer-readable medium described herein may further include operations, features, means, or instructions for storing the one or more offers in a database associated with the user.

Another method is described. The method may include determining one or more characteristics of a user of a performance marketing application and receiving one or more offers that are relevant to the user based on the one or more characteristics, where each of the one or more offers is associated with at least one of a set of multiple advertisers associated with the performance marketing application. The method may also include outputting the one or more offers at an output device of a computing device associated with the user, accepting the one or more offers, and receiving an advertisement associated with the one or more offers at the computing device.

Another apparatus is described. The apparatus may include a processor, memory in electronic communication with the processor, and instructions stored in the memory. The instructions may be executable by the processor to cause the apparatus to determine one or more characteristics of a user of a performance marketing application and receive one or more offers that are relevant to the user based on the one or more characteristics, where each of the one or more offers is associated with at least one of a set of multiple advertisers associated with the performance marketing application. The instructions may be executable by the processor to cause the apparatus to output the one or more offers at an output device of a computing device associated with the user, accept the one or more offers, and receive an advertisement associated with the one or more offers at the computing device.

Another apparatus is described. The apparatus may include means for determining one or more characteristics of a user of a performance marketing application and means for receiving one or more offers that are relevant to the user based on the one or more characteristics, where each of the one or more offers is associated with at least one of a set of multiple advertisers associated with the performance marketing application. The apparatus may also include means for outputting the one or more offers at an output device of a computing device associated with the user, means for accepting the one or more offers, and means for receiving an advertisement associated with the one or more offers at the computing device.

Another non-transitory computer-readable medium storing code is described. The code may include instructions executable by a processor to determine one or more characteristics of a user of a performance marketing application and receive one or more offers that are relevant to the user based on the one or more characteristics, where each of the one or more offers is associated with at least one of a set of multiple advertisers associated with the performance marketing application. The code may also include instructions executable by a processor to output the one or more offers at an output device of a computing device associated with the user, accept the one or more offers, and receive an advertisement associated with the one or more offers at the computing device.

In some examples of the method, apparatuses, and non-transitory computer-readable medium described herein, the advertisement includes a tracker and the method, apparatuses, and non-transitory computer-readable medium may include further operations, features, means, or instructions for linking the advertisement to at least one channel of the user.

Some examples of the method, apparatuses, and non-transitory computer-readable medium described herein may further include operations, features, means, or instructions for receiving an indication of an award made to the user based on a determination that the tracker may have been used to complete a transaction associated with the one or more offers.

Some examples of the method, apparatuses, and non-transitory computer-readable medium described herein may further include operations, features, means, or instructions for publishing information related to the one or more offers on a webpage associated with the user.

Some examples of the method, apparatuses, and non-transitory computer-readable medium described herein may further include operations, features, means, or instructions for determining that the advertisement associated with the one or more offers may have expired, requesting a new advertisement based on the one or more offers, receiving the new advertisement based on the one or more offers, and linking the advertisement to the at least one channel of the user or a different channel of the user.

### BRIEF DESCRIPTION OF THE DRAWINGS

FIG. 1 illustrates an example of a system that supports a performance marketing application in accordance with aspects of the present disclosure.

FIG. 2 illustrates an example of a process flow that supports a performance marketing application in accordance with aspects of the present disclosure.

FIGS. 3-5 illustrate flowcharts of example methods that support a performance marketing application in accordance with aspects of the present disclosure.

FIGS. 6A and 6B illustrate example screenshots that supports a performance marketing application in accordance with aspects of the present disclosure.

FIG. 7 shows a block diagram of a commercial computing device that supports a performance marketing application in accordance with aspects of the present disclosure.

FIG. 8 show a block diagram of a user device that supports a performance marketing application in accordance with aspects of the present disclosure.

FIG. 9 shows a diagram of a device that supports a performance marketing application in accordance with aspects of the present disclosure.

FIGS. 10 and 11 show flowcharts illustrating example methods that support performance marketing application in accordance with aspects of the present disclosure.

### DETAILED DESCRIPTION

Performance marketing enables awards to be earned through promoting products through various channels. Advertisers frequently enter contracts with advertising agencies, affiliate networks, publishers, promoters, or influencers with large audiences in order to promote their products or services. A promoter may promote a product to their network of consumers under an advertising contract, and when someone purchases the product through the promoter, the promoter may earn a commission. However, typically promoters need to be well connected in order to have access to these advertising contracts. This may leave out many promoter, influencers, or individuals who have sizable networks but do not have access these deals.

Techniques described herein provide an ad sharing platform for connecting promoters with advertising deals or other types of offers for different advertisers. This way, smaller, more typical promoters have an opportunity to perform advertising services for the advertiser. As used herein, promoter may refer to any person or entity that may interface with the ad sharing platform to promote an advertisement (also referred to herein as an ad), including but not limited to, consumers, customers, bloggers, authors, influencers, publishers, individuals, entities, companies, corporations, organizations, users, and the like. A promoter may promote an advertisement from an advertiser, which may correspond to a product, service, concept, or the like (referred to herein as products or services). As used herein, advertiser may refer to any person or entity that may interface with the ad sharing platform to provide an advertisement to a promoter, including but not limited to, individuals, corporations, organizations, partnerships, government entities, users, or other business organization or entity. As used herein, user may refer to any promotor or advertiser who interacts with the ad sharing platform.

The ad sharing platform may present a graphical user interface (GUI) that users (for example, advertisers and promoters) may use to display, add, or find offers. The ad sharing platform may connect to one or more databases, such as, for example, one or more databases 145. A first database may be populated by advertisers who have offers that can be available for performance marketing. A second database may include characteristics or other information about the promoters who have signed up for the platform. The databases may include identifiers, tags, keywords, or the like that can be used for the platform to match promoters and advertisers or offers, for a promoter to find offers, or for an advertiser to find promoters to which offers may be presented. The ad sharing platform may be a performance marketing application that may enable sharing of advertisements by promoters to consumers and may include a performance marketing application. As used herein, the term platform may be used to refer to the ad sharing platform.

An advertiser may enter one or more offers into the platform, provide the offers to the platform, or provide information about the offers. As used herein, an offer may include information regarding an agreement for a promoter to promote or otherwise provide an advertisement for one or more products or services. The information may include an identity of the advertiser, an identity of the one or more products or services, terms for a contract between the advertiser and promoter if the offer is accepted, a deal, discount, or promotion for the one or more products or services, an identification of an award to the promoter if the one or more products or services are promoted or purchased, desired channels for the advertisement, preferences for certain promoters, keywords or tags to aid with searching, other information, or combinations thereof. Included with the information may be at least portions of an advertisement, such as one or more images, ad copy, graphics, promotional materials, or the like.

An offer may be presented to promoters based on characteristics of the promoters, the offer, or the advertiser. For example, preference for the offer may be given to promoters who are on one or more desired channels indicated in the offer. As used herein, a channel may refer to any medium by which the advertisement may be displayed or otherwise outputted, including, for example, a social media channel, a website, an email, a text, a gaming platform, a server, or the like. For example, a gaming company may indicate it is looking for promoters who are on certain gaming platforms. In other examples, the offer may also be presented to promoters having obtained certain levels within the ad sharing platform. For example, a promoter may achieve levels within the ad sharing platform based at least in part on successful promotions. An offer may identify a required level of any promoter who may have access to the offer.

Upon successful promotion of the advertisement according to the terms of the offer, the promoter may receive an award. For example, the offer may define that the promoter receives a reward whenever an advertisement is posted or upon successful completion of a purchase of the product or service. An award may be any benefit provided to the promoter for promotion of the one or more products or services according to the terms of the offer, including, but not limited to, payments, fees, commission, discounts, products, services, access to exclusive offers, promotions, or the like.

Using the ad sharing platform, a promoter may browse the one or more offers. The offers may be presented to the promoter based on characteristics of the promoter , channels that the promoter uses or is a part of, prior offers accepted by the promoter, or the like. In some examples, the promoter may search the ad sharing platform for offers that they would like to join and advertisements they would like to promote. When a promoter accepts an offer, the ad sharing platform may provide an advertisement related to the offer to the promoter. The promoter may present the advertisement to or otherwise share information regarding the offer with at least a portion of their network on one or more channels.

As used herein, a channel can be any means by which a promoter may reach one or more individuals who may be members of the promoter's network. A channel may be a social media channel, an email, a text, a blog audience, a gaming guild, a website, a listserv, a server, a media sharing network, a social network, a discussion forum, a bookmarking network, a chat application, a content curation network, a consumer review network, a publishing network, a sharing economy network, a video hosting website, a mobile application, a radio channel, a television channel, or the like. Consumers may be recipients of emails, social media audience members, individuals who view a webpage, anyone who interacts with the channel, or the like. A network may include consumers of a channel. For example, a network may be a group of individuals who visit a blog of a promoter or who are on a listserv associated with the promoter. As used herein, network may refer to any consumers of a promoter's channel who may be exposed to the advertisement.

The ad sharing platform may use a tracking system to link those offers accepted by the promoter with the promoter's network. When a consumer is interested in an advertisement that was shared by the promoter, the consumer may solicit a transaction (for example, a sale through a website of the advertiser). The tracking system may present a link to the consumer (for example, a Uniform Resource Locator (URL)), which may be used to record the transaction and any other analytical data associated with the purchase. In other examples, other types of trackers or means of tracking may be used, including but not limited to tracking pixels, cookies, device fingerprinting, tracking plugins, scripts, caches, local storage, software development kits (SDKs), or the like.

If a consumer purchases the product or service, the promoter may receive an award, such as a commission, according to the terms of the offer. In some examples, the advertiser or platform may confirm the authenticity of the purchase transaction before making payment. Once a transaction is confirmed or the consumer's payment has cleared, the advertiser may make the award to the platform or promoter. If the platform manages the award, the platform may process this payment and provide a corresponding commission to the promoter. Otherwise the award may go directly to the promoter. In some examples, the platform may advance a commission to the promoter. The platform may also provide various metrics to the advertiser regarding the offers, advertisements, and promoters.

The platform may also provide each promoter with a network location, such as a webpage, to store the offers that the promoter has accepted. The offers may continue to be current even after specific advertisements associated with the offers are no longer available. The promoter may use the store to quickly obtain new advertisements or to place links on at least some channels.

The techniques described herein may democratize advertisements and provide an easily used platform to connect advertisers and promoter. The platform may also provide a mechanism for tracking purchases by consumers through an advertisement associated with the offer that is linked to from a channel of the promoter. When a completed transaction is made and confirmed not to be fraudulent, the advertiser or platform may provide commission to the promoter. The techniques provide ways for maintaining offers long-term, creating a pathway for new advertisements to quickly reach consumers. The platform may increase a customer base, increase sales, and save time for promoters and advertisers.

Aspects of the disclosure are initially described in the context of performance marketing. Aspects of the disclosure are also illustrated by and described with reference to process flows and flowcharts that relate to a performance marketing application. Aspects of the disclosure are further illustrated by and described with reference to apparatus diagrams, system diagrams, and more flowcharts that relate to a performance marketing application.

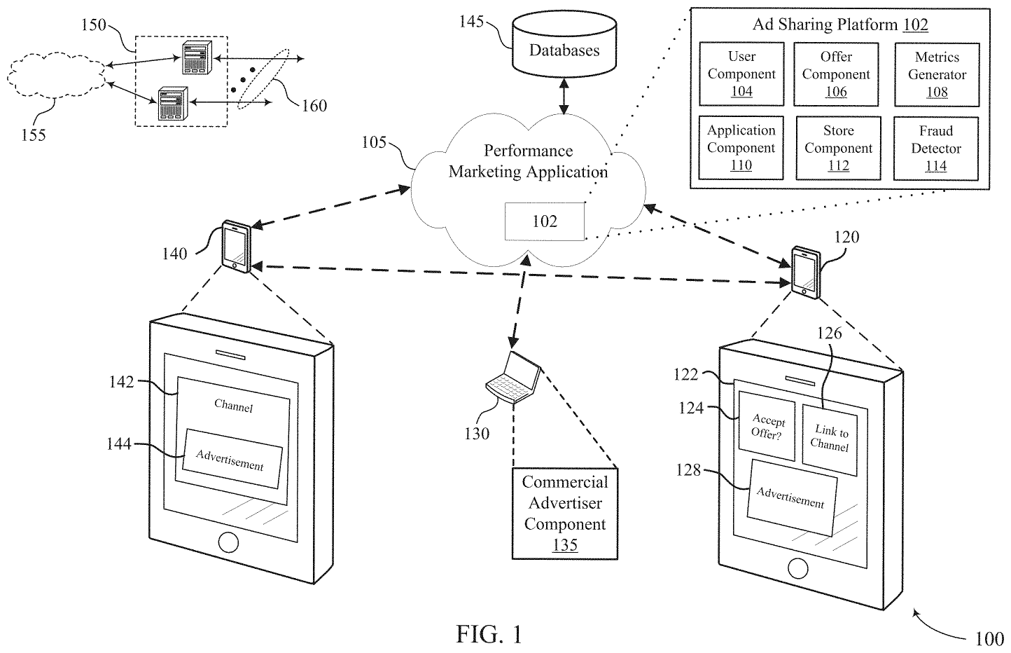

FIG. 1 illustrates an example of a performance marketing system 100 that supports a performance marketing application 105 in accordance with aspects of the present disclosure. The performance marketing system 100 may include a performance marketing application 105, a promoter computing device 120, an advertiser computing device 130, a consumer computing device 140, and a core network 150. In some examples, the performance marketing system 100 may be any type of wired or wireless network. In some examples, the performance marketing system 100 may support the performance marketing application 105 that can connect promoters with offers from advertisers.

As used herein, the term user refers to any individual or entity that interacts with the ad sharing platform 102, such as a promoter or an advertiser. As used herein, and discussed above, the term promoter refers to any individual or entity that uses one or more channels to reach consumers, including consumers in the promoter's network. A promoter may have any size network and use any number of channels. As used herein, and discussed above, an advertiser may be any individual or entity who may advertise a product or service, such as a corporate entity, a company, a subsidiary, a distributor, a business organization, a non-profit organization, a non-government entity, a charity organization, a special interest group, or the like.

The performance marketing application 105 may connect promoters, advertisers, and consumers into a single platform. The performance marketing application 105 may include an ad sharing platform 102 that executes a computer program that may implement techniques described herein. For example, the ad sharing platform 102 may provide a platform for advertisers to add offers and upload advertisements that may be accessed by promoters. The ad sharing platform 102 may also provide a platform that enables promoters to access different offers, search offers, and upload characteristics about themselves and their channels. The ad sharing platform 102 may also provide various services that support the ad sharing platform 102, such as a storing accepted offers for promoters, maintaining searchable databases, providing metrics to promoters and advertisers, suggesting offers to promoters, suggesting promoters to advertisers, and the like.

Any of the computing devices 120, 130, and 140 may include or may be referred to as a mobile device, a wireless device, a remote device, a handheld device, or a subscriber device, or some other suitable terminology, where the “device” may also be referred to as a unit, a station, a terminal, or a client, among other examples. A computing device 120, 130, and 140 may also include or may be referred to as a personal electronic device such as a cellular phone, a personal digital assistant (PDA), a tablet computer, a laptop computer, or a personal computer.

The computing devices 120, 130, and 140 may be devices in different forms or having different capabilities. The computing devices 120, 130, and 140 described herein may be able to communicate with various types of devices, such as other computing devices, the performance marketing application 105, or network equipment including macro eNBs or gNBs, small cell eNBs or gNBs, or relay base stations, among other examples (e.g., nodes of the core network 150, relay devices, integrated access and backhaul (IAB) nodes, or other network equipment).

The core network 150 may provide user authentication, access authorization, tracking, Internet Protocol (IP) connectivity, and other access, routing, or mobility functions. The core network 150 may be an evolved packet core (EPC) or 5G core (5GC) or other type of core network, which may include at least one control plane entity that manages access and mobility and at least one user plane entity that routes packets or interconnects to external networks. The performance marketing application 105 or computing devices 120, 130, and 140 may interface with the core network 150 through one or more backhaul links 160. The control plane entity may manage non-access stratum (NAS) functions such as mobility, authentication, and bearer management for the computing devices 120, 130, and 140 and the performance marketing application 105 associated with the core network 150. User IP packets may be transferred through the user plane entity, which may provide IP address allocation as well as other functions. The user plane entity may be connected to IP services 155 for one or more network operators. The IP services 155 may include access to the Internet, Intranet(s), an IP Multimedia Subsystem (IMS), or a Packet-Switched Streaming Service.

The performance marketing application 105 may be connected to the one or more databases 145. The one or more databases 145 may store information regarding users of the platform (e.g., promoters and advertisers). For example, the one or more databases 145 may include a promoter database that stores characteristics of promoters, such as promoter preferences, topics the promoter is interested in, which channels the promoter uses, demographic information, sales metrics, information related to offers, and the like. The one or more databases 145 may also include an offer database which stores information related to offers, such as which advertiser generated the offer, which promoter accepted the offer, time the offer originated, an expiration time of the offer, metrics about the offer (such as contract terms, price, commission fee, etc.), and the like. The one or more databases 145 may also include an advertiser database that includes information about the advertiser, such as types of products and services, size, offers, customers, preferences, sales metrics, which promoters the advertiser has worked with (e.g., promoters who have accepted offers from the advertiser), and the like. In some other examples, the databases 145 may include other information. In other examples, other databases 145 that store other information may be included.

The ad sharing platform 102 may include a user component 104, an offer component 106, a metrics generator 108, an application component 110, a store component 112, and a fraud detector 114. In other examples of the ad sharing platform 102, other components may be included. In some other examples of the ad sharing platform 102, some of the components shown in the example of FIG. 1 are not included.

The ad sharing platform 102 may determine one or more characteristics of a user of the performance marketing application 105. The user may be a promoter or an advertiser. In an example where the user is a promoter, the ad sharing platform 102 may identify one or more offers from a set of offers that are relevant to the user based on the one or more characteristics, where each of the set of offers is associated with at least one of a set of advertisers associated with the performance marketing application or ad sharing platform, and present the one or more offers to a computing device associated with the user. The ad sharing platform 102 may determine an acceptance of a first offer of the one or more offers and provide an advertisement associated with the first offer to the promoter computing device 120.

The ad sharing platform 102 may use artificial intelligence or machine learning techniques to match promoters with offers or advertisers. In some examples, the ad sharing platform 102 may make suggestions of offers to advertisers, based on various metrics and analysis of past performances.

The user component 104 may set up an account for a promoter or advertiser. The account may include basic information about the promoters or advertiser. The user component 104 may determine one or more characteristics of a user of the performance marketing application 105. The user component 104 may determine one or more characteristics of a promoter of the ad sharing platform 102. In some examples, the user component 104 may request information related to the one or more characteristics of the promoter. In some examples, the user component 104 may store information related to the one or more characteristics of the user in a promoter database associated with the performance marketing application 105.

In examples where the user is a promoter, the user component 104 may query the user for characteristics of the promoter that may be used to match the promoter with offers, promote offers to the promoter, or promote the promoter to an advertiser. Example characteristics include which channels the user participates in, hobbies or likes of the user, demographic information such as geographic region of residence, ethnicity, age, sex, sexual identity and orientation, education level, or other information such as field of study or work, or the like. The user component 104 may also determine previous offers associated with the promoter, metrics related to completed transactions of the promoter, fraud levels related to the promoter's offers, lead scores, and the like. Some or all of the characteristics may be opt-in or opt-out for the promoter. That is, the promoter may not have to provide all of the requested information in order to participate in the performance marketing application 105. The user component 104 may interface with a promoter database and store relevant information in the promoter database. The information may be store keywords, tags, etc., associated with the characteristics. The performance marketing application 105 may protect the privacy of the information of the promoters and advertisers.

The user component 104 may also determine a level of the promoter within the performance marketing application 105. The level may be based on productivity of the promoter, number of leads, number of bad leads, profit generated, number of channel posts, length of the promoter's use of the ad sharing platform 102, or the like. The level may provide different experiences or offers to the promoter.

Examples where the user is an advertiser, the user component 104 may determine one or more characteristics of the advertiser. The user component 104 may determine one or more characteristics of the advertiser, such as types of products or services the advertiser promotes or sells, target consumer demographics, preferred channels, preferences regarding promoters, metrics associated with the advertiser, or the like.

The offer component 106 may process offers related to advertisers. The offer component 106 may receive or request offers from an advertiser. The offer component 106 may store information about the offers in an offer database. The offer component 106 may process the offers by matching them to promoters, which may be performed by comparing characteristics or qualities of the offer with those of the promoter, such as type of product, demographic target, keywords, or other examples. In some examples, the offer component 106 may request permission from the advertiser via a commercial advertiser component 135 before presenting an offer to the promoter. In some examples, the offer component may include a visual form of a legal contract.

The offer component 106 may identify one or more offers from a set of offers that are relevant to the user based on the one or more characteristics of the user. The offer component 106 may provide the one or more offers to a promoter computing device 120 associated with a promoter and determine an acceptance of a first offer of the one or more offers. The offer component 106 may provide an advertisement associated with the first offer to the promoter computing device 120.

The offer component 106 may identify one or more offers from a set of offers that are relevant to the promoter based on the one or more characteristics, where each of the set of offers is associated with at least one of a set of advertisers associated with the performance marketing application or ad sharing platform. In some examples, the offer component 106 may provide the one or more offers to a promoter computing device 120 associated with the promoter. In some examples, the offer component 106 may determine an acceptance of a first offer of the one or more offers. In some examples, the offer component 106 may provide an advertisement associated with the first offer to the promoter computing device 120.

In some examples, the offer component 106 may determine that a URL associated with a offer has been used to complete a transaction. In some examples, the offer component 106 may award a payment or fee to the promoter based on the determination that the URL has been used to complete the transaction. In some examples, the offer component 106 may output an indication of the payment to the promoter.

In some examples, the offer component 106 may store the set of offers in an offer database associated with the performance marketing application 105, where each offer in the offer database is associated with an advertiser of the set of advertisers. In some examples, the offer component 106 may identify one or more offers from a set of offers that are relevant to the promoter is further based on a previous offer associated with the promoter.

In some examples, the offer component 106 may link the first offer to at least one channel of the promoter. In some examples, the offer component 106 may identify the one or more offers from the set of offers based on one or more characteristics associated with the one or more offers. In some cases, at least some offers of the set of offers in the offer database is associated with an expiration of the offer.

The metrics generator 108 may determine metrics for promoters and advertisers. For a promoter, the metrics generator 108 may compute metrics regarding sales, such as, for example, how many times consumers linked to an advertisement, how many times consumers completed transactions, ratios of offers to completed transactions, false leads, fraudulent activity, numbers of postings, numbers of re-postings, or the like. In some examples, the metrics generator 108 may calculate how successful a specific advertisement is, how often offers are accepted, which offers are more successful than others for a specific promoter or among promoters, or the like. The metrics generator 108 may provide some or all of these metrics to the promoter and advertisers. The metrics generator 108 may also determine metrics for advertisers, such as how many offers are accepted, rate of offer acceptance, number of completed transactions, effectiveness of the advertisements, or the like.

The application component 110 may manage applications related to the performance marketing application 105, such as a web-based application accessible by promoters and advertisers, a mobile application for a promoter to use on a mobile device, or a mobile application for an advertiser to use on a mobile device.

The store component 112 may maintain a page or other stored space for a promoter to keep accepted offers. The store component 112 may publish information related to the one or more offers on a webpage associated with the promoter. In some examples, the store component 112 may store the one or more offers in a database associated with the promoter. These accepted offers may be active for a long time, and the promoter may be able to access the stored offers in order to quickly add advertisements to their channels. The store component 112 may maintain a list of active offers and a historical list of offers that are no longer active. The store component 112 may include any URLs or other tracking mechanisms associated with offers or advertisements.

The fraud detector 114 may authenticate any transactions indicated by the advertiser. The fraud detector 114 may determine whether the transaction associated with the offer is a valid transaction. When a consumer completes a transaction using an advertisement with a tracker promoted by a promoter, the performance marketing application 105 may detect the completed transaction or the advertiser may inform the performance marketing application 105 of the completed transaction. The fraud detector 114 may apply fraud logic which uses various methods to ensure that the completed transaction is authentic. If not, the fraud detector 114 may prevent a payment being made to the promoter. The fraud detector 114 may void fraudulent transactions.

The fraud detector 114 may periodically pull or generate reports on a promoter and remove any transactions deemed fraudulent. The fraud detector 114 may flag any promoter having a number of transactions returned that is more than or equal to a threshold number. The fraud detector 114 may also flag any promoter having more than or equal to a threshold number of bad leads. If a promoter is flagged for being associated with certain levels of fraud, the performance marketing application 105 may indicate this to the advertisers, reduce a level of the promoter, or present less offers to the promoter. In some examples, the fraud detector 114 may suspend or terminate an account of the promoter with the performance marketing application 105 if fraud reaches above a suspension threshold level of fraud. The fraud detector 114 may also deactivate a promoter's account if the promoter does not use the performance marketing application 105 within a certain time period.

The performance marketing application 105, or its sub-components, may be implemented in hardware, code (e.g., software or firmware) executed by a processor, or any combination thereof. If implemented in code executed by a processor, the functions of the performance marketing application 105, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The performance marketing application 105, or its sub-components, may be physically located at various positions, including being distributed such that portions of functions are implemented at different physical locations by one or more physical components. In some examples, the performance marketing application 105, or its sub-components, may be a separate and distinct component in accordance with various aspects of the present disclosure. In some examples, the performance marketing application 105, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The example of FIG. 1 also includes the advertiser computing device 130, which may be a computing device associated with an advertiser. The advertiser computing device 130 may include a commercial advertiser component 135 that may be used to access the ad sharing platform 102. The commercial advertiser component 135 may include a GUI or other input/output device to receive information from the advertiser. The commercial advertiser component 135 may be used to create advertisements, deals, and offers in the ad sharing platform 102. An advertiser may set a specific budget for the offer, specific time frames for the offer, target audiences, or other information. In some examples, the ad sharing platform 102 may request offers from the commercial advertiser component 135, then promote the offers to one or more promoters.

The commercial advertiser component 135 may also display metrics related to the offers and relevant promoters. In some examples, the commercial advertiser component 135 may request authorization before an offer is provided to a promoter. The commercial advertiser component 135 may also provide options to the advertiser to purchase a subscription to the ad sharing platform 102 or analytical metrics regarding one or more promoters or channels.

The promoter computing device 120 may be associated with a promoter. The promoter computing device 120 shows an example of an output device 122, which in FIG. 1 is shown as a GUI. The promoter computing device 120 may run an application that accesses the ad sharing platform 102. The promoter computing device 120 may output requests for information, offers, confirmations, advertisements, metrics, and the like. As shown in the example of FIG. 1, the output device 122 may display a request to accept an offer 124, a link to a channel 126, and an advertisement 128. If the offer is accepted, the promoter may link the advertisement 128 to one or more channels 126. The advertisement 128 may include a tracker, such as a URL, pixel, cookie, or the like.

The consumer computing device 140 may be associated with a consumer. The consumer may view a channel 142 of the promoter, which may display a link to the advertisement 144. The channel 142 may be a channel of the promoter which the consumer is viewing or otherwise interacting with on the consumer's computing device 140. The consumer may interact with the advertisement 144 to make a purchase or otherwise complete a transaction. The advertisement 144 may be associated with a tracker, such as a URL, pixel, or cookie, which the ad sharing platform 102 may track to determine that a purchase has been completed. When the consumer interacts with the advertisement 144, it may link the consumer to a webpage, perform a transaction, or provide another means for the consumer to complete a transaction.

The performance marketing system 100 as described herein may enable promoters, including smaller promoters, to access offers from advertisers that are otherwise not normally available to them. The ad sharing platform 102 may provide an easy-to-use platform that connects advertisers with promoters. The ad sharing platform 102 may save advertisers time in finding promoters, expand an advertiser's advertisement reach, provide income for the promoter, compute metrics, and maintain information related to the offers.

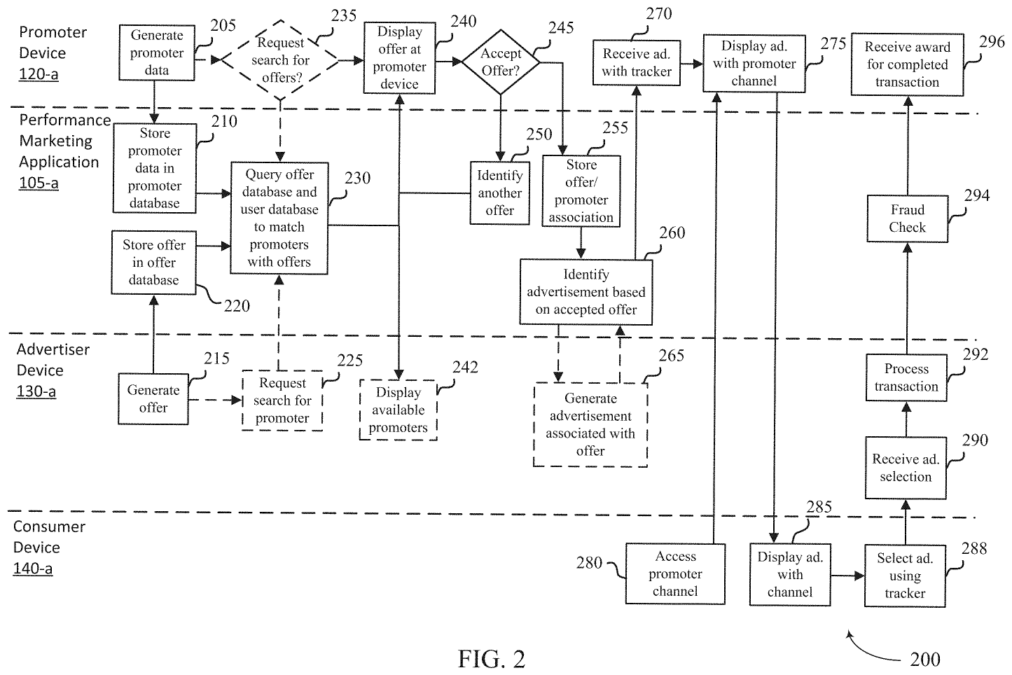

FIG. 2 illustrates an example of a process flow 200 that supports a performance marketing application in accordance with aspects of the present disclosure. In some examples, the process flow 200 may implement aspects of the performance marketing system 100 as described in FIG. 1. The process flow 200 may include a performance marketing application 105-a, which may be examples of one or more aspects of the performance marketing application 105 as described in FIG. 1. The process flow 200 may also include a promoter device 120-a, which may be examples of one or more aspects of the promoter computing device 120 as described in FIG. 1. The process flow 200 may also include an advertiser device 130-a, which may be examples of one or more aspects of the advertiser computing device 130 as described in FIG. 1. The process flow 200 may also include a consumer device 140-a, which may be examples of one or more aspects of the computing device 140 as described in FIG. 1. The various steps described with respect to FIG. 2 may be performed by one or more instances of an ad sharing platform, such as the ad sharing platform shown in FIG. 1, on the different computer devices described herein, such as the promoter device 120-a, the advertiser device 130-a, and the consumer device 140-a.

At 205, the promoter device 120-a may generate data related to a promoter and provide it to the performance marketing application 105-a. The promoter device 120-a may generate this data at the request of the performance marketing application 105-a. In some examples, the promoter device 120-a outputs a request for information from the promoter, which may assist the performance marketing application 105-a in finding appropriate offers. At 210, the performance marketing application 105-a may store the promoter data in a promoter database.

At 215, the advertiser device 130-a may generate an offer and provide it to the performance marketing application 105-a. The advertiser device 130-a may generate the offer at the request of the performance marketing application 105-a. In some examples, the advertiser device 130-a may output a request for offers at the advertiser device 130-a. At 220, the performance marketing application 105-a may store the offers in an offer database.

At 230, the performance marketing application 105-a may query the offer database and the promoter database in order to match offers with promoters. In some examples, the query may be initiated by the promoter device 120-a or the advertiser device 130-a. For example, at 235, the promoter device 120-a may request a search for offers, which may be because the promoter wants to view the possible offers that are available. The promoter may be able to set parameters for the search. Likewise, at 225, the advertiser device 130-a may request a search for promoters from the performance marketing application 105-a, which may be because the advertiser device 130-a wants to see which promoters are available. In some examples, the performance marketing application 105-a may generate the query. The performance marketing application 105-a may perform the query regardless of how it was triggered.

After the query is completed, the performance marketing application 105-a may send information to the promoter device 120-a or to the advertiser device 130-a. For example, the performance marketing application 105-a may send information on the available promoters to the advertiser device 130-a, which may display or otherwise output the information at 242. The performance marketing application 105-a may send information about the available offers to the promoter device 120-a, which may display or otherwise output the one or more offers at the promoter device 120-a at 240.

At 245, the promoter device 120-a may send a signal accepting the offer or rejecting the offer. This may be based on whether the promoter accepts the offer or not. If the promoter rejects the offer, the performance marketing application 105-a may identify another offer at 250 and provide the offer to the promoter device 120-a. If the promoter accepts the offer via the promoter device 120-a, the performance marketing application 105-a may store information about the offer, the promoter, and the advertiser associated with the offer. For example, the performance marketing application 105-a may store the information in an offer database or a promoter database. In other examples, the performance marketing application 105-a may store information about the offer in a webpage or application page for the promoter to access or link to at a future time.

At 260, the performance marketing application 105-a may identify an advertisement based on the accepted offer. The offer may include terms of the agreement, whereas the advertisement may contain a specific ad with a tracker or other tracking mechanism. In some examples, the performance marketing application 105-a may generate the advertisement and the tracking mechanism based on parameters from the offer. In other examples, the advertiser device 130-a may generate or otherwise receive an advertisement associated with the offer at 265 and provide it to the performance marketing application 105-a. The performance marketing application 105-a may send the offer to the promoter device 120-a.

At 270, the promoter device 120-a may receive the advertisement with a tracking mechanism, which may be a URL or pixel, for example. The promoter device 120-a may link the ad to a channel of the promoter. For example, the promoter may create a social media post, blog post, email, forum post, video post, etc., and attach the advertisement to the post. In some examples, the promoter may attach the advertisement to an already existing post or channel.

A consumer device 140-a may access the promoter's channel at 280 and display the advertisement that is linked on the channel at 285. The consumer device 140-a may select something within the advertisement, such as a URL or text or image associated with the URL, at 288 and may be linked to a webpage, for example, where the consumer may complete a transaction with the advertiser. The advertisement may include a hyperlink, anchored link, or the like. At 290, the advertiser device 130-a may receive an indication that the consumer linked to the advertisement. At 292, the advertiser device 130-a may process the transaction.

At 294, the advertiser device 130-a may provide an indication of the completed transaction to the performance marketing application 105-a, which may perform a fraud check on the completed transaction. In some examples, the advertiser device 130-a does not provide the indication, but rather the tracking mechanism automatically informs the performance marketing application 105-a of the completed transaction. In some examples, the consumer device 140-a accessing the link of the advertisement may be enough to generate revenue for the promoter (or trigger the award described in the offer), rather than a completed transaction. The fraud check may confirm the authenticity of the access or completed transaction or confirm that the consumer is an actual person and not a bot accessing the link.

If the fraud check indicates the transaction is authentic, the promoter device 120-a may receive an award for the completed transaction at 296. The award may be as detailed in the offer, such as a commission fee or a discount. The promoter device 120-a may output an indication of the award to the promoter.

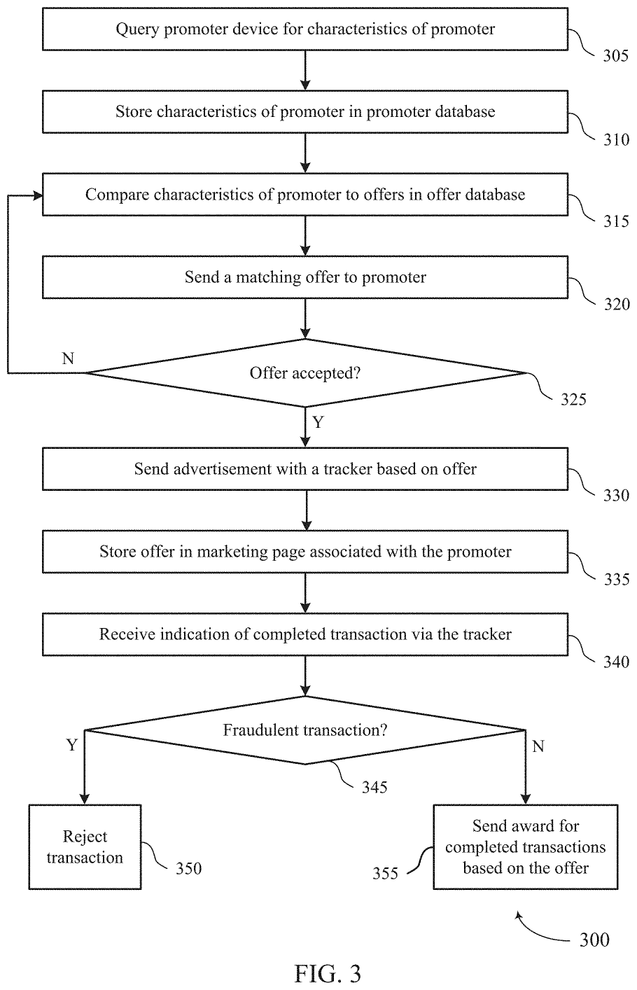

FIG. 3 illustrates an example of a flowchart of a method 300 that supports a performance marketing application in accordance with aspects of the present disclosure. In some examples, the method 300 may implement aspects of performance marketing system 100. The operations of the method 300 may be implemented by a performance marketing application 105 or its components as described herein. For example, the operations of the method 300 may be performed by an ad sharing platform 102 as described with reference to FIG. 1. In some examples, a performance marketing application may execute a set of instructions to control the functional elements of the performance marketing application to perform the functions described below. Additionally, or alternatively, a performance marketing application may perform aspects of the functions described below using special-purpose hardware.

At 305, the method 300 may query a promoter device for characteristics of the promoter. The information may include characteristics of the promoter relevant for finding offers for the promoter. In some examples, 305 may be skipped if the performance marketing application already has information on the characteristics of the promoter. In some examples, the request may be for updated information. At 310, the method 300 may include storing the characteristics of the promoter in a promoter database. In some examples, the method 300 may update or add to the information already stored in the promoter database.

At 315, the method 300 may compare characteristics of the promoter to one or more offers in the offer database. The comparison may check demographics, social networks, channels, interests, metrics, or the like. At 320, the method 300 may send a matching offer to the promoter. At 325, the method 300 determines if the offer has been accepted. If it is not accepted, the method 300 returns to 315 and looks for another offer. If the offer is accepted, the method 300 proceeds to 330.

At 330, the method 300 sends an advertisement with a tracker based on the offer. At 335, the method 300 may store the offer in a marketing page associated with the promoter, for the future use of the promoter. A marketing page may be a webpage or mobile application that a promoter may use to access a store of offers or advertisements that the promoter has accepted or used.

In some examples, the promoter may use the offer to generate the advertisement, according to their purposes, aesthetics, channel requirements, network or other consumer preferences, or the like. In some examples, the promoter may share the offer on one or more channels, modify the message of an advertisement, or create the advertisement (including graphics) prior to sharing. In some examples, the promoter can anchor the offer text to a URL without showing the text of the URL.

At 340, the method 300 may include receiving an indication of a completed transaction via the tracker. In some examples, the method 300 receives the indication of a completed transaction from the entity that provided the offer. At 345, the method 300 may determine if the transaction is fraudulent or authentic. If it is fraudulent, the method 300 may reject the transaction at 350. If it is authentic, the method 300 may cause a payment to be sent to the promoter for the completed transaction based on the offer. In some examples, the method 300 may update the offer database and the promoter database based on the completed transaction. For example, the method 300 may include increasing a score of the promoter for completing a sale or indicating that the promoter has generated a false lead.

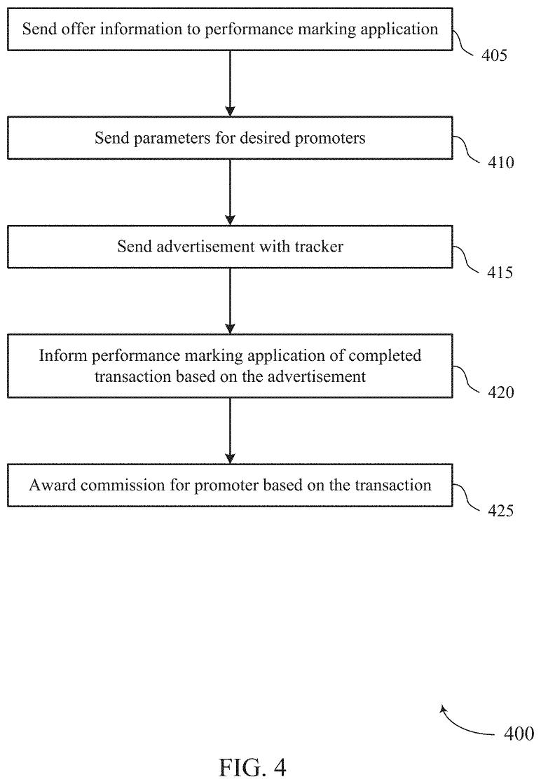

FIG. 4 illustrates an example flowchart of a method 400 that supports a performance marketing application in accordance with aspects of the present disclosure. In some examples, the method 400 may implement aspects of performance marketing system 100. The operations of method 400 may be implemented by an advertiser computing device 140 associated with an advertiser or its components as described herein. In some examples, the advertiser computing device 140 may execute a set of instructions to control the functional elements of the performance marketing application to perform the functions described below. Additionally, or alternatively, the advertiser computing device 140 may perform aspects of the functions described below using special-purpose hardware.

At 405, the method 400 may send one or more offers to the performance marketing application. The offer may define contract terms for the promoter to accept the offer from the advertiser and may include the advertisements for use by the promoter. The contract terms may include commission rate, terms of compliance with the offer, permitted or prohibited social media or channel types or posts, and the like. In some examples, the advertiser computing device inputs the offer into the ad sharing platform of the performance marketing application. In other examples, the performance marketing application itself inputs the offer to the ad sharing platform. In some examples, the advertiser may pay a fee to promote a particular offer to one or more promoters. The performance marketing application may output a request to the advertiser to determine if the advertiser would like to promote the offer to one or more promoters. If the advertiser accepts, the performance marketing application may obtain a payment from the advertiser and promote the offer to the identified promoters (which may be based on a level of the promoters, history of the promoters with the advertiser, or other characteristic).

At 410, the method 400 may send parameters for desired promoters to receive the offer. The parameters may include demographics, channel types, sales metrics, or the like. For example, the advertiser may only want to work with promoters who have a sales score above a threshold amount, have attained a specific level within the performance marketing application, or who have a number of false leads below a certain level. In some examples, 410 may be skipped if the performance marketing application already has information on the desired characteristics of promoters or if the advertiser does not wish to set parameters. In some examples, the method 400 may include storing the offer and parameters in the offer database. In some examples, the method 400 may update or add to the information already stored in the offer database.

At 415, the method 400 may send an advertisement with a tracker based on the offer. The method 400 may send the advertisement when the offer has been accepted. In other examples, the method 400 does not include sending the advertisement because the advertisement is included with, or can be generated from, the offer.

At 420, the method 400 may include informing the performance marketing application of a completed transaction via the tracker. In some examples, the method 400 may receive the indication of a completed transaction from the performance marketing application. In some examples, the transaction may be completed when a consumer clicks on a link in the advertisement or offer. In other examples, the transaction may be completed when an impression associated with the advertisement or offer is created. As used herein, an impression is when the advertisement or related form of digital media renders on the consumer's screen. In some examples, the transaction may be completed when a consumer interacts with the advertisement or offer in any way.

At 425, the method 400 may award the commission or other award to the promoter based on the completed transaction. In some examples, the method 400 does not actively include 425, and rather payments are automatically caused to be made to the promoter by the performance marketing application.

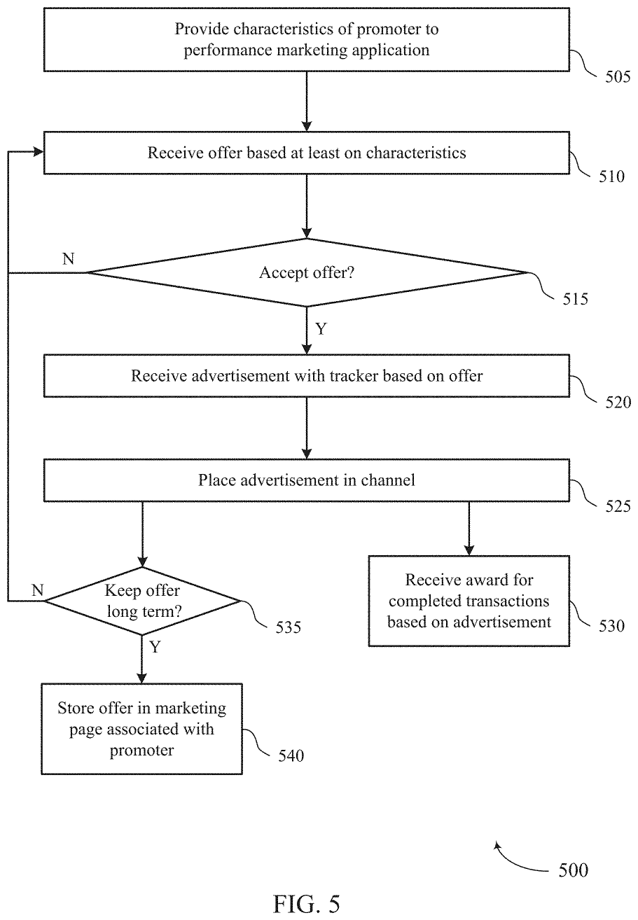

FIG. 5 illustrates an example flowchart of a method 500 that supports a performance marketing application in accordance with aspects of the present disclosure. In some examples, the method 500 may implement aspects of performance marketing system 100. The operations of method 500 may be implemented by a promoter computing device 120 associated with a promoter or its components as described herein. In some examples, the promoter computing device 120 may execute a set of instructions to control the functional elements of the performance marketing application to perform the functions described below. Additionally, or alternatively, the promoter computing device 120 may perform aspects of the functions described below using special-purpose hardware.

At 505, the method 500 may provide characteristics of the promoter relevant for finding offers on the platform. In some examples, 505 may be skipped if the platform already has information on the characteristics of the promoter. In some examples, the promoter may supply updated information. At 510, the method 500 may include receiving an offer based at least in part on the characteristics. The method 500 may include displaying the offer at an output device of the promoter computing device 120.

At 515, the method 500 may determine whether to accept or reject the offer. The promoter may indicate that the offer is accepted or rejected by interacting with the performance marketing application. If the promoter does not accept the offer, the method 500 returns to 510 and receives another offer from the performance marketing application. If the offer is accepted, the method 500 proceeds to 520.

At 520, the method 500 may receive an advertisement with a tracker based on the accepted offer. At 525, the method 500 may include placing the advertisement in a channel. For example, the promoter may copy and paste a link associated with the advertisement or may use features of the performance marketing application to automatically upload the advertisement to the channel.

At 530, the method 500 may include receiving an award (e.g., commission) for a transaction that was completed based on the advertisement. This may happen as many times as consumers use the advertisement to complete a transaction, such as making a purchase, clicking a link, or rendering an impression. At 535, the method 500 may include determining whether the promoter wants to keep the offer long term (for example, for future use). If so, the method 500 includes storing the offer in a marketing page associated with the promoter at 540. If not, the method 500 may return a new offer.

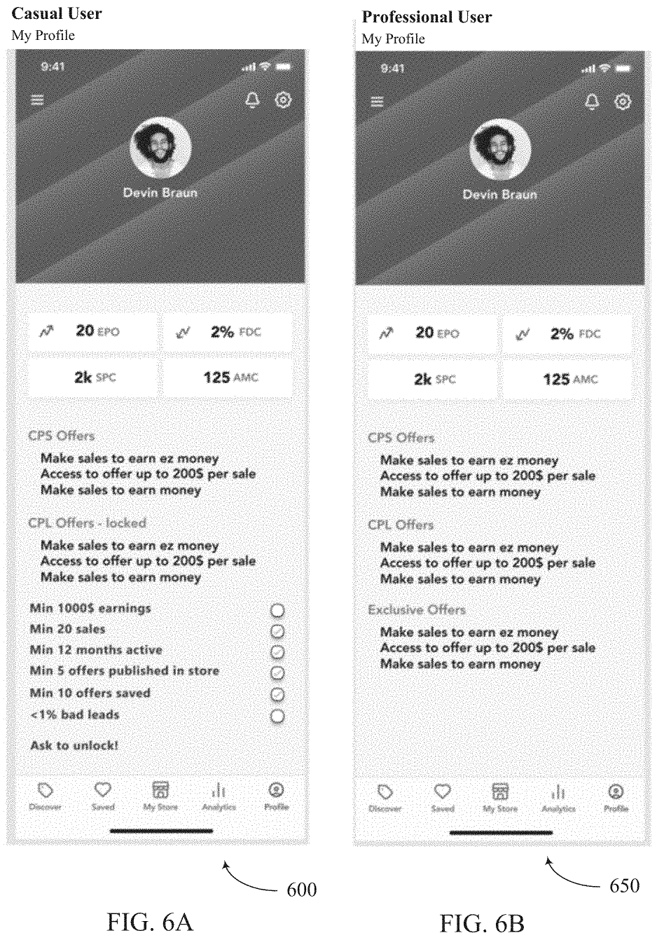

FIG. 6A illustrates an example screenshot 600 that supports a performance marketing application in accordance with aspects of the present disclosure. The screenshot 600 may be an example screenshot of a performance marketing application output at a promoter computing device 120 of the promoter. Screenshot 600 may be for a casual, infrequent user or an active user of the performance marketing application. A profile of the promoter may be provided, as well as metrics related to their sales.

The screenshot 600 may also include a level of the promoter. The level may be a level within the performance marketing application that may be based on metrics (such as sales and false leads). Some offers may be unavailable to the casual promoter because the advertisers of those offers may want to work with promoters of a certain level. As shown in the screenshot 600, the casual promoter may have to reach certain metrics before they can unlock the next level.

FIG. 6B illustrates an example screenshot 650 that supports a performance marketing application in accordance with aspects of the present disclosure. The screenshot may be an example screenshot of a performance marketing application output at a promoter computing device 120 of the promoter. Screenshot 650 may be for a professional, frequent user of the performance marketing application. A profile of the promoter may be provided, as well as metrics related to their sales. The screenshot 650 may also include a level of the promoter, which in this example provides exclusive offers to promoters with that level.

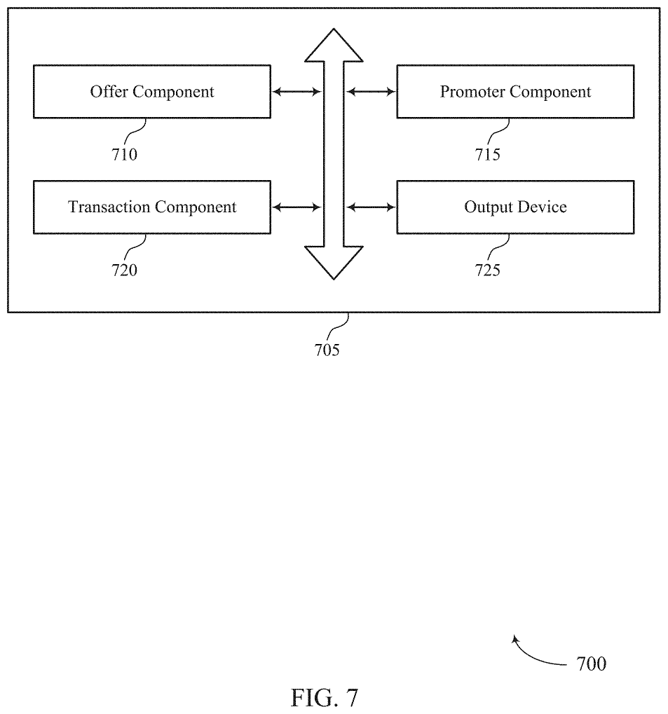

FIG. 7 shows a block diagram 700 of an advertiser computing device 705 that supports a performance marketing application in accordance with aspects of the present disclosure. The advertiser computing device 705 may be an example of aspects of an advertiser computing device 130 described herein. The advertiser computing device 705 may include an offer component 710, a promoter component 715, a transaction component 720, and an output device 725. Each of these components may communicate, directly or indirectly, with one another (e.g., via one or more buses).

The offer component 710 may be used to generate one or more offers and provide them to the performance marketing application. The offer component 710 may also generate one or more advertisements based at least in part on the offers. In some examples, the offer component 710 may enter the one or more offers into the performance marketing application.

The promoter component 715 may provide characteristics of a desired promoter for a specific offer to the performance marketing application. The promoter component 715 may also keep metrics regarding promoters who have accepted offers.

The transaction component 720 may determine when a transaction has been made related to the advertisement. The transaction component 720 may provide an indication of a completed transaction to the performance marketing application. The transaction component 720 may determine that a transaction has been made related to the advertisement based on purchases, subscriptions, clicks, impressions, or the like. The transaction component 720 may enable commissions to be paid to promoters upon completed transactions or based at least in part on the terms of the accepted offer.

The output device 725 may output information related to the performance marketing application. For example, the output device 725 may output notifications of offers being accepted, transactions completed, payments made, or the like. The output device 725 may also provide a GUI for a user to interact with the performance marketing application. In some examples, the output device 725 may be a touch screen on a mobile application.

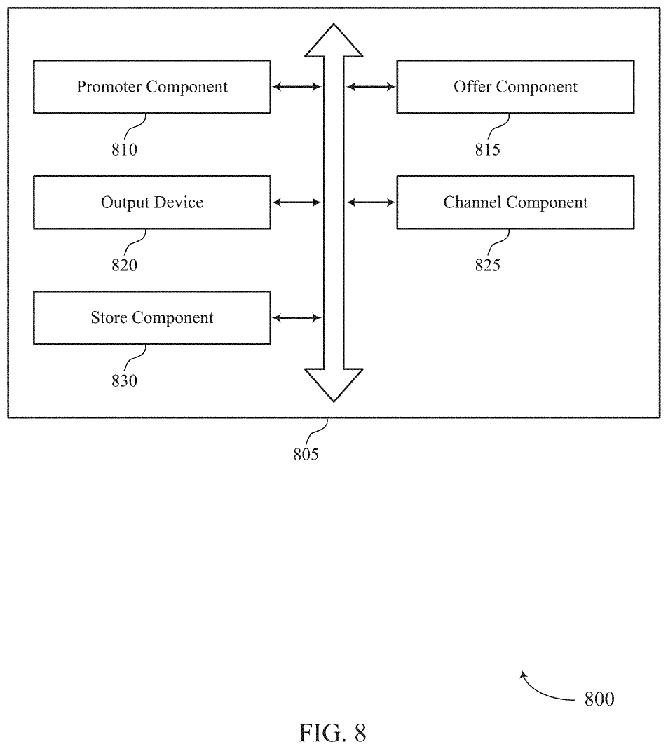

FIG. 8 shows a block diagram 800 of a device 805 that supports a performance marketing application in accordance with aspects of the present disclosure. The device 805 may be an example of aspects of a promoter computing device 120 or promoter device 120-a as described herein. The device 805 may include a promoter component 810, an offer component 815, an output device 820, a channel component 825, and a store component 830. Each of these modules may communicate, directly or indirectly, with one another (e.g., via one or more buses).

The promoter component 810 may determine one or more characteristics of the promoter of a performance marketing application. The promoter component 810 may enable the promoter to input information about themselves or update information that is no longer current.

The offer component 815 may receive one or more offers that are relevant to the promoter based on the one or more characteristics, where each of the one or more offers is associated with at least one of a set of advertisers associated with the performance marketing application. In some examples, the offer component 815 may accept the one or more offers. In some examples, the offer component 815 may receive an advertisement associated with the one or more offers at the device 805. In some examples, the offer component 815 may receive an indication of a payment made to the promoter based on a determination that the tracker has indicated the advertisement was used to complete a transaction associated with the offer.

In some examples, the offer component 815 may determine that the advertisement associated with the one or more offers has expired. In some examples, the offer component 815 may request a new advertisement based at least in part on the one or more offers. In some examples, the offer component 815 may receive the new advertisement based at least in part on the one or more offers.

The output device 820 may output information related to the performance marketing application. The output device 820 may output the one or more offers at an output device of a computing device associated with the promoter. The output device 820 may also output notifications, such as a notification of payment. The output device 820 may also provide a GUI for a promoter to interact with the performance marketing application. In some examples, the output device 820 may be a touch screen on a mobile application.

The channel component 825 may link the advertisement to at least one channel of the promoter. In some examples, the channel component 825 may link the advertisement to at least one channel of the promoter or a different channel of the promoter. The channel component 825 may interface with different channels, such as social media, webpages, or other services.

The store component 830 may publish information related to the one or more offers on a marketing page associated with the promoter. The marketing page may be a webpage or displayed using an application on a mobile device, for example. The marketing page may be accessed via the ad sharing platform.

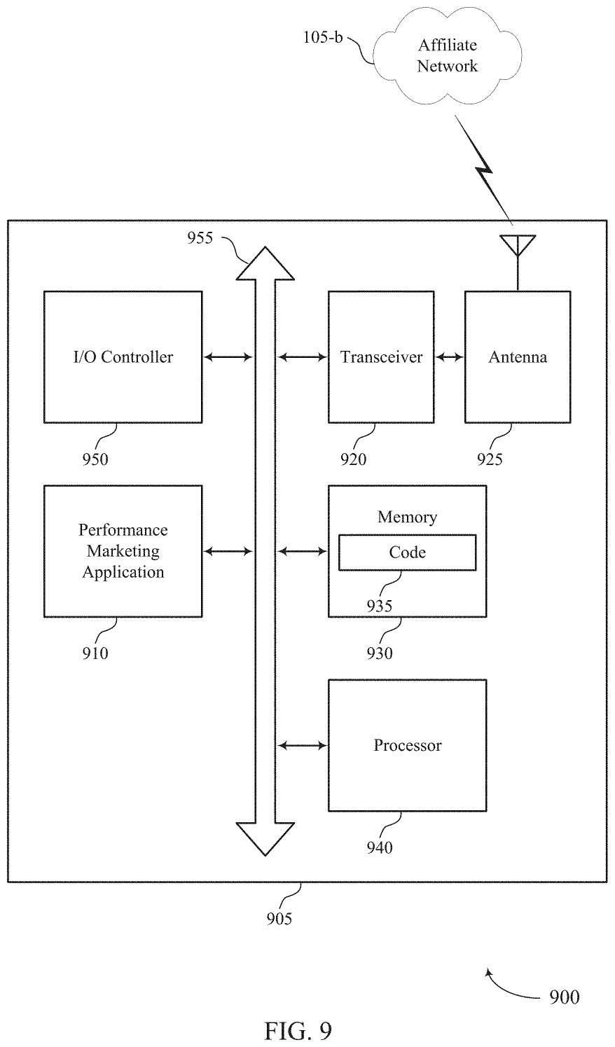

FIG. 9 shows a diagram of a system 900 including a device 905 that supports a performance marketing application in accordance with aspects of the present disclosure. The device 905 may be an example of or include the components of an ad sharing platform 102, a promoter computing device 120, an advertiser computing device 130, a consumer device 140, a device 805, or an advertiser computing device 705 as described herein. The device 905 may include components for bi-directional voice and data communications including components for transmitting and receiving communications, including a performance marketing application 910, a transceiver 920, an antenna 925, memory 930, a processor 980, and an I/O controller 950. These components may be in electronic communication via one or more buses (e.g., bus 955).

The performance marketing application 910 may determine one or more characteristics of a promoter of the performance marketing application, identify one or more offers from a set of offers that are relevant to the promoter based on the one or more characteristics, where each of the set of offers is associated with at least one of a set of advertisers associated with the performance marketing application, present the one or more offers to a computing device associated with the promoter, determine an acceptance of a first offer of the one or more offers, and provide an advertisement associated with the first offer to the computing device, such as the device 905.

The performance marketing application 910 may determine one or more characteristics of a promoter of a performance marketing application, receive one or more offers that are relevant to the promoter based on the one or more characteristics, where each of the one or more offers is associated with at least one of a set of advertisers associated with the performance marketing application, accept the one or more offers, receive an advertisement associated with the one or more offers at the computing device, and output the one or more offers at an output device of a computing device associated with the promoter.

Transceiver 920 may communicate bi-directionally, via one or more antennas, wired, or wireless links. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas. Transceiver 920 may receive information such as packets, data, or control information associated with various information radio channels (e.g., control channels, data channels, and information related to performance marketing application, etc.). Information may be passed on to other components of the device 905. The transceiver 920 may utilize a single antenna or a set of antennas. Transceiver 920 may transmit signals generated by other components of the device 905. The transceiver 920 may utilize a single antenna or a set of antennas.

In some cases, the device 905 may include a single antenna 925. However, in some cases the device may have more than one antenna 925, which may be capable of concurrently transmitting or receiving multiple wireless transmissions.

The memory 930 may include random-access memory (RAM), read-only memory (ROM), or a combination thereof. The memory 930 may store computer-readable code 935 including instructions that, when executed by a processor (e.g., the processor 940) cause the device to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting performance marketing application).

The I/O controller 950 may manage input and output signals for the device 905. The I/O controller 950 may also manage peripherals not integrated into the device 905. In some cases, the I/O controller 950 may represent a physical connection or port to an external peripheral. In some cases, the I/O controller 950 may utilize an operating system such as iOS®, ANDROID®, MS-DOS®, MS-WINDOWS®, OS/2®, UNIX®, LINUX®, or another known operating system. In other cases, the I/O controller 950 may represent or interact with a modem, a keyboard, a mouse, a touchscreen, or a similar device. In some cases, the I/O controller 950 may be implemented as part of a processor. In some cases, a user may interact with the device 905 via the I/O controller 950 or via hardware components controlled by the I/O controller 950.

The code 935 may include instructions to implement aspects of the present disclosure, including instructions to support wireless communications and a performance marketing system. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

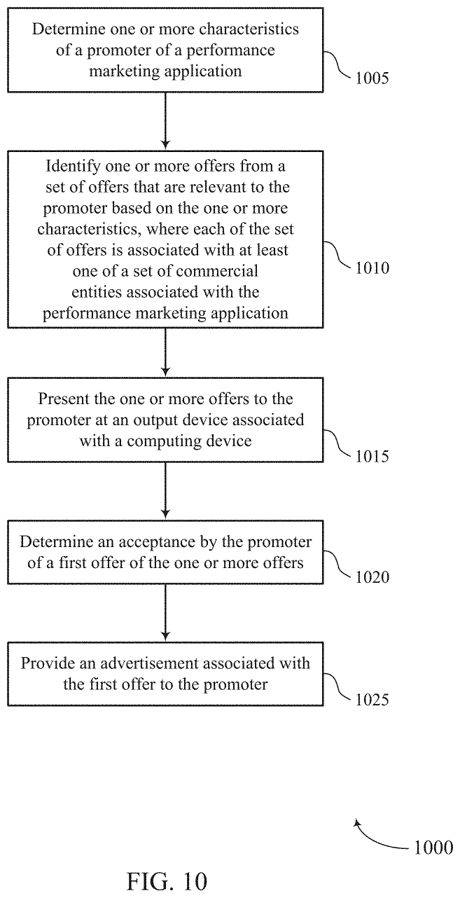

FIG. 10 shows a flowchart illustrating a method 1000 that supports a performance marketing application in accordance with aspects of the present disclosure. The operations of method 1000 may be implemented by a performance marketing application 105 or its components as described herein. For example, the operations of method 1000 may be performed by a performance marketing system as described with reference to FIGS. 1 through 3. In some examples, a performance marketing application may execute a set of instructions to control the functional elements of the performance marketing application to perform the functions described below. Additionally, or alternatively, a performance marketing application may perform aspects of the functions described below using special-purpose hardware.

At 1005, the performance marketing application may determine one or more characteristics of a promoter of the performance marketing application. The operations of 1005 may be performed according to the methods described herein. In some examples, aspects of the operations of 1005 may be performed by a promoter device as described with reference to FIGS. 1 through 3.

At 1010, the performance marketing application may identify one or more offers from a set of offers that are relevant to the promoter based on the one or more characteristics, where each of the set of offers is associated with at least one of a set of advertisers associated with the performance marketing application. The operations of 1010 may be performed according to the methods described herein. In some examples, aspects of the operations of 1010 may be performed by an offer component as described with reference to FIGS. 1 through 3.

At 1015, the performance marketing application may provide the one or more offers to a computing device associated with the promoter. The operations of 1015 may be performed according to the methods described herein. In some examples, aspects of the operations of 1015 may be performed by an offer component as described with reference to FIGS. 1 through 3.

At 1020, the performance marketing application may determine an acceptance of a first offer of the one or more offers. The operations of 1020 may be performed according to the methods described herein. In some examples, aspects of the operations of 1020 may be performed by an offer component as described with reference to FIGS. 1 through 3.

At 1025, the performance marketing application may provide an advertisement associated with the first offer to the computing device. The operations of 1025 may be performed according to the methods described herein. In some examples, aspects of the operations of 1025 may be performed by an offer component as described with reference to FIGS. 1 through 3.

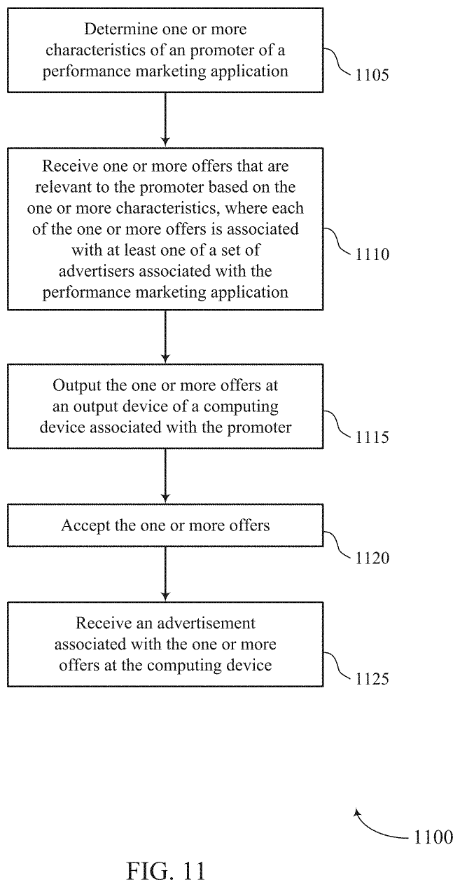

FIG. 11 shows a flowchart illustrating a method 1100 that supports a performance marketing application in accordance with aspects of the present disclosure. The operations of method 1100 may be implemented by a computing device or its components as described herein. For example, the operations of method 1100 may be performed by a promoter computing device 120 as described with reference to FIGS. 1 and 2. In some examples, a computing device may execute a set of instructions to control the functional elements of the computing device to perform the functions described below. Additionally, or alternatively, a computing device may perform aspects of the functions described below using special-purpose hardware.

At 1105, the computing device may determine one or more characteristics of a promoter of a performance marketing application. The operations of 1105 may be performed according to the methods described herein. In some examples, aspects of the operations of 1105 may be performed by an undefined as described with reference to FIGS. 1, 2, 4, 8, and 9.

At 1110, the computing device may receive one or more offers that are relevant to the promoter based on the one or more characteristics, where each of the one or more offers is associated with at least one of a set of advertisers associated with the performance marketing application. The operations of 1110 may be performed according to the methods described herein. In some examples, aspects of the operations of 1110 may be performed by a promoter component as described with reference to FIGS. 1, 2, 4, 8, and 9.

At 1115, the computing device may output the one or more offers at an output device of a computing device associated with the promoter. The operations of 1115 may be performed according to the methods described herein. In some examples, aspects of the operations of 1115 may be performed by an offer component as described with reference to FIGS. 1, 2, 4, 8, and 9.

At 1120, the computing device may accept the one or more offers. The operations of 1125 may be performed according to the methods described herein. The operations of 1120 may be performed according to the methods described herein. In some examples, aspects of the operations of 1120 may be performed by an output device as described with reference to FIGS. 1, 2, 4, 8, and 9.

At 1125, the computing device may receive, at the computing device, an advertisement associated with the one or more offers. In some examples, aspects of the operations of 1125 may be performed by an offer component as described with reference to FIGS. 1, 2, 4, 8, and 9.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
determining one or more characteristics of a promoter of a performance marketing application;
identifying one or more offers from a plurality of offers that are relevant to the promoter based at least in part on the one or more characteristics, wherein each of the plurality of offers is associated with at least one of a plurality of advertisers associated with the performance marketing application;
providing the one or more offers to a computing device associated with the promoter, wherein a graphical image associated with the one or more offers is configured for display on an output device of the computing device;
determining an acceptance of a first offer of the one or more offers; and
providing an advertisement associated with the first offer to the computing device, wherein a graphical image associated with the advertisement is configured for display on the output device of the computing device;
storing the plurality of offers in an offer database associated with the performance marketing application, wherein each offer in the offer database is associated with an advertiser of the plurality of advertisers; and
storing information related to the one or more characteristics of the promoter in a promoter database associated with the performance marketing application.

2. The method of claim 1, wherein the advertisement includes a tracker, the method further comprising:
determining that the tracker has been used to complete a transaction associated with the first offer;
causing an award to be made to the promoter based at least in part on the determination that the tracker has been used to complete the transaction; and
outputting an indication of the award to the promoter.

3. The method of claim 2, further comprising:
determining that the transaction associated with the first offer is a valid transaction.

4. canceled.

5. The method of claim 1, further comprising:
storing the first offer of the one or more offers at a network location associated with the promoter; and
maintaining the first offer as current after expiration of the advertisement associated with the first offer.

6. The method of claim 1, wherein:
identifying one or more offers from a plurality of offers that are relevant to the promoter is further based at least in part on a previous offer associated with the promoter.

7. The method of claim 1, further comprising:
linking the advertisement to at least one channel of the promoter, wherein the at least one channel comprises a social media channel, an email, a text, a blog audience, a gaming guild, a listserv, a server, a media sharing network, a social network, a discussion forum, a bookmarking network, a chat application, a content curation network, a consumer review network, a publishing network, a sharing economy network, a video hosting website, a mobile application, a radio channel, or a television channel.

8. The method of claim 1, further comprising:
requesting information related to the one or more characteristics of the promoter.

9-10. Canceled.

11. The method of claim 5, wherein the network location comprises a webpage associated with the promoter, the method further comprising:
publishing information related to the one or more offers on the webpage associated with the promoter, wherein the information includes a list of accepted offers, a historical list of offers that are no longer active, and a plurality of tracking mechanisms associated with each of the one or more offers.

12. The method of claim 1, wherein identifying one or more offers from the plurality of offers that are relevant to the promoter further comprises:
identifying the one or more offers from the plurality of offers based at least in part on one or more characteristics associated with the one or more offers.

13. The method of claim 1, further comprising:
storing the one or more offers in a database associated with the promoter.

14. A method, comprising:
determining one or more characteristics of a promoter of a performance marketing application;
receiving one or more offers that are relevant to the promoter based at least in part on the one or more characteristics, wherein each of the one or more offers is associated with at least one of a plurality of advertisers associated with the performance marketing application;
outputting a graphical image of the one or more offers at an output device of a computing device associated with the promoter;
accepting the one or more offers; and
receiving an advertisement associated with the one or more offers at the computing device;
outputting a graphical image of the advertisement associated with the one or more offers at the output device;
storing the one or more offers in an offer database associated with the performance marketing application, wherein each offer in the offer database is associated with an advertiser of the plurality of advertisers; and
storing information related to the one or more characteristics of the promoter in a promoter database associated with the performance marketing application.

15. The method of claim 14, wherein the advertisement includes a tracker, the method further comprising:
linking the advertisement to at least one channel of the promoter, wherein the at least one channel comprises a social media channel, an email, a text, a blog audience, a gaming guild, a listserv, a server, a media sharing network, a social network, a discussion forum, a bookmarking network, a chat application, a content curation network, a consumer review network, a publishing network, a sharing economy network, a video hosting website, a mobile application, a radio channel, or a television channel.

16. The method of claim 15, further comprising:
receiving an indication of an award made to the promoter based at least in part on a determination that the tracker has been used to complete a transaction associated with the one or more offers.

17. The method of claim 14, further comprising:
publishing information related to the one or more offers on a webpage associated with the promoter.

18. The method of claim 14, further comprising:
determining that the advertisement associated with the one or more offers has expired;
requesting a new advertisement based on the one or more offers;
receiving the new advertisement based on the one or more offers; and
linking the advertisement to at least one channel of the promoter or a different channel of the promoter.

19. An apparatus, comprising:
a processor,
memory coupled with the processor; and
instructions stored in the memory and executable by the processor to cause the apparatus to:
determine one or more characteristics of a promoter of a performance marketing application;
identify one or more offers from a plurality of offers that are relevant to the promoter based at least in part on the one or more characteristics, wherein each of the plurality of offers is associated with at least one of a plurality of advertisers associated with the performance marketing application;
provide the one or more offers to a computing device associated with the promoter, wherein a graphical image associated with the one or more offers is configured for display on an output device of the computing device;
determine an acceptance of a first offer of the one or more offers;
provide an advertisement associated with the first offer to the computing device, wherein a graphical image associated with the advertisement is configured for display on the output device of the computing device;
store the plurality of offers in an offer database associated with the performance marketing application, wherein each offer in the offer database is associated with an advertiser of the plurality of advertisers; and
store information related to the one or more characteristics of the promoter in a promoter database associated with the performance marketing application.

20. The apparatus of claim 19, wherein the advertisement includes a tracker, and the instructions are further executable by the processor to cause the apparatus to:
determine that the tracker has been used to complete a transaction associated with the first offer;
causing an award to be made to the promoter based at least in part on the determination that the tracker has been used to complete the transaction; and
output an indication of the award to the promoter.

21. The method of claim 1, wherein the offer database is populated by one or more advertisers associated with the plurality of offers.

22. The method of claim 1, wherein the one or more offers comprises information regarding an agreement, wherein the information includes an identity of the advertiser, an identity of one or more products or services, terms for a contract between the advertiser and promoter if the one or more offers are accepted, an identification of an award to the promoter if the one or more products or services are promoted or purchased, and one or more desired channels for the advertisement.

23. The method of claim 22, wherein the information further includes one or more images or graphics associated with the advertisement.
